(19) United States
(12) Patent Application Publication
(10) Pub. No.: US 2023/0015123 A1
(43) Pub. Date: Jan. 19, 2023

(54) SYSTEMS AND METHODS FOR PERSONALLY IDENTIFIABLE INFORMATION METADATA GOVERNANCE

(71) Applicant: JPMORGAN CHASE BANK, N.A., New York, NY (US)

(72) Inventors: Shanthi KAKUMANU, New Albany, OH (US); Errol Kevin Banzon ALBA, Mira Loma, CA (US); Sean FINNESSY, Columbus, OH (US); Todd TARNEY, Sunbury, OH (US); Kajal GORAI, Lewis Center, OH (US); Scott R. STEVENS, Wilmington, DE (US); Chris BEAVER, Lewis Center, OH (US); Matthew E. FORNEY, Westerville, OH (US)

(21) Appl. No.: 17/377,136

(22) Filed: Jul. 15, 2021

(51) Int. Cl. G06F 21/62; G06F 16/242

(52) U.S. Cl. CPC G06F 21/6245; G06F 16/2433

(57) ABSTRACT

Systems and methods for personally identifiable information metadata governance are disclosed. In one embodiment, a method for personally identifiable information (PII) metadata governance may include: (1) receiving, by a PII metadata identification program executed by an electronic device, a data processing flow for a project; (2) retrieving, by the PII metadata identification program, code for the data processing flow from a code repository; (3) identifying, by the PII metadata identification program, potential PII access points in the code; (4) determining, by the PII metadata identification program, that the potential PII access points match PII access points in a PII reference data database; (5) confirming, by the PII metadata identification program, that an individual assigned to the project is entitled access the PII data; and (6) granting, by the PII metadata identification program, access to the PII data to the individual.

### BACKGROUND OF THE INVENTION

### 1. Field of the Invention

Embodiments relate generally to systems and methods for personally identifiable information metadata governance.

### 2. Description of the Related Art

Organizations, such as financial institutions, store personally identifiable information, or PII, for their customers. Certain of the organization's employees may need to access this PII as part of their job requirements. Granting access to employees often requires managers to review and approve requests, and to have the approval stored for audit purposes. Because there can be a substantial number of databases, this may be a long and involved process.

### SUMMARY OF THE INVENTION

Systems and methods for personally identifiable information metadata governance are disclosed. In one embodiment, a method for personally identifiable information (PII) metadata governance may include: (1) receiving, by a PII metadata identification program executed by an electronic device, a data processing flow for a project; (2) retrieving, by the PII metadata identification program, code for the data processing flow from a code repository; (3) identifying, by the PII metadata identification program, potential PII access points in the code; (4) determining, by the PII metadata identification program, that the potential PII access points match PII access points in a PII reference data database; (5) confirming, by the PII metadata identification program, that an individual assigned to the project is entitled access the PII data; and (6) granting, by the PII metadata identification program, access to the PII data to the individual.

In one embodiment, the potential PII access points may be identified at a table and column level.

In one embodiment, the PII reference data database may include metadata for data elements in an organization.

In one embodiment, the data elements may be classified based whether they include PII.

In one embodiment, the PII metadata identification program may identify potential PII access points in the code by scanning and parsing the code to identify the potential PII access points.

In one embodiment, the potential PII access points may include SQL queries.

In one embodiment, the step of confirming, by the PII metadata identification program, that an individual assigned to the project is entitled access the PII data may include requesting, by the PII metadata identification program, approval for the individual to access the PII; and receiving, by the PII metadata identification program, approval for the individual to access the PII.

In one embodiment, the method may further include generating, by the PII metadata identification program, an audit log comprising individuals entitled to access the PII.

According to another embodiment, an electronic device may include a computer processor and a memory storing a PII metadata identification program. When executed by the computer processor, the PII metadata identification program may cause the computer processor to: receive a data processing flow for a project; retrieve code for the data processing flow from a code repository; identify potential PII access points in the code; determine that the potential PII access points match PII access points in a PII reference data database; confirm that an individual assigned to the project is entitled access the PII data; and grant access to the PII data to the individual.

In one embodiment, the potential PII access points may be identified at a table and column level.

In one embodiment, the PII reference data database may include metadata for data elements in an organization.

In one embodiment, the data elements may be classified based whether they include PII.

In one embodiment, the PII metadata identification program may identify potential PII access points in the code by scanning and parsing the code to identify the potential PII access points.

In one embodiment, the potential PII access points may include SQL queries.

In one embodiment, the PII metadata identification program may confirm that an individual assigned to the project is entitled access the PII data by requesting approval for the individual to access the PII and receiving approval for the individual to access the PII.

In one embodiment, the PII metadata identification program may further cause the computer processor to generate an audit log comprising individuals entitled to access the PII.

According to another embodiment, a system may include: a first electronic device comprising a first computer processor and executing a PII metadata identification program; a second electronic device comprising a second computer processor and executing a data processing flow for a project; a code repository comprising code for the data processing flow; and a PII reference data database identifying PII access points, wherein the PII reference data database may include metadata for data elements in an organization, wherein the data elements are classified based whether they include PII. The PII metadata identification program may: receive the data processing flow for the project from the second electronic device; retrieve the code for the data processing flow from the code repository; identify potential PII access points in the code by scanning and parsing the code to identify the potential PII access points; determine that the potential PII access points match the identified PII access points in the PII reference data database; confirm that an individual assigned to the project is entitled access the PII data by requesting approval for the individual to access the PII; and receiving approval for the individual to access the PII; and grant access to the PII data to the individual.

In one embodiment, the potential PII access points may be identified at a table and column level.

In one embodiment, the potential PII access points may include SQL queries.

In one embodiment, the PII metadata identification program may generate an audit log comprising individuals entitled to access the PII.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a depicts a system for personally identifiable information metadata governance according to an embodiment; and

FIG. 2 depicts a method for personally identifiable information metadata governance according to an embodiment.

### DETAILED DESCRIPTION OF PREFERRED EMBODIMENTS

Embodiments relate generally to systems and methods for personally identifiable information metadata governance.

Embodiments introduce a layer of security that the computer application may consult before making an outbound call. This layer verifies that the call that is to be made is safe to execute.

Embodiments may identify data processing flows for each project in which PII data is used. The data processing flows may be in applications, programs, etc. Embodiments may identify SQL queries within the data processing flows by scanning and parsing the processing flows to extract the table and column level metadata that are called in the data processing flow. The table and column level metadata may be compared to metadata that is stored in an organization's metadata repository, where each data element is classified based on whether it contains PII, and each data element may be associated with the table(s) and column(s) in which it is stored.

In one embodiment, the metadata repository may only identify data elements that contain PII.

If the data processing flow accesses or uses data elements that are classified as PII, a notification/request may be generated for the project owner or a manager to certify that the individuals working on the project are authorized to access the PII-classified data. The project owner or manager may also remove an individual from the project should the individual not be entitled to access the PII-classified data. In one embodiment, the project owner or manager may periodically certify access to the PII-classified data, or to take an appropriate action.

In one embodiment, the project owner or manager may certify individuals, take an action, etc. using a user interface that may be provided on the project owner's or manager's electronic device.

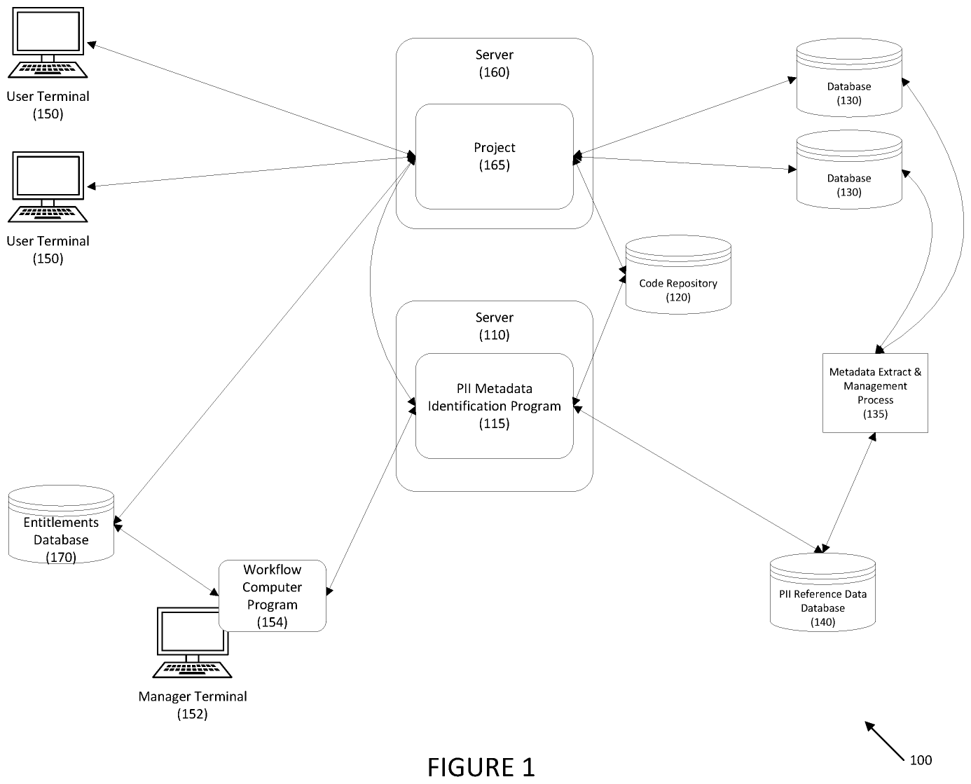

Referring to FIG. 1, a system for personally identifiable information metadata governance is disclosed according to one embodiment. System 100 may include server 110 that may execute PII metadata identification program 115. PII metadata identification program 115 may be a computer program that may review code for a project data processing flow from code repository 120 and may identity potential PII access points, such as SQL queries, in the code.

PII metadata identification program 115 may interface with workflow program 154 that may be executed, for example, on manager terminal 152 or electronic device to certify PII elements and remove any outliers. Workflow program 154 may further receive permission from a manger or similar to allow user access to PII, or to deny user access to PII.

PII metadata identification program 115 may generate audit reports identifying access to PII, including an identification of the person who accessed the PII, a timestamp, etc. The audit report may be stored in a database. The audit report may be generated with each PII data access, periodically, on demand, or as otherwise necessary and/or desired.

Code repository 120 may store code, including code snippets. In one embodiment, code repository 120 may store code that is organic to an institution, as well as code from external sources. Code repository 120 may interface with user terminals 150 and manager terminal 152.

Databases 130 may store any data for an organization, including PII. In one embodiment, databases 130 may store data, including the PII, in tables, and the columns may identity data that may be PII.

Metadata extract and management process 135 may extract metadata from databases 130. The metadata may identity data elements by database, schema, tables and columns. It may store the metadata in PII reference data database 140. In one embodiment, the metadata extract and management process 135 may be centralized, or it may be local to each database 130.

PII reference data 140 may store PII metadata reference data that identifies locations of PII data in an organization. The PII metadata reference data may identify storage locations at the column label (e.g., for PII stored in tables).

User terminals 150 may be used by employees to execute code in code repository 120. Users using user terminals 150 may be granted or denied access based on their entitlements in entitlements database 170. For example, depending on a user's entitlements to access PII, the user may or may not be permitted to execute certain code that may access PII.

User terminals 150 may access project 165 that may be executed on one or more electronic devices, such as server 160, which may access code repository 120 and databases 130. Project 165 may include data processing flows, such as applications, programs, etc. that may access data in databases 130. User access to PII in databases 130 may be governed by the user's entitlements in entitlements database 170.

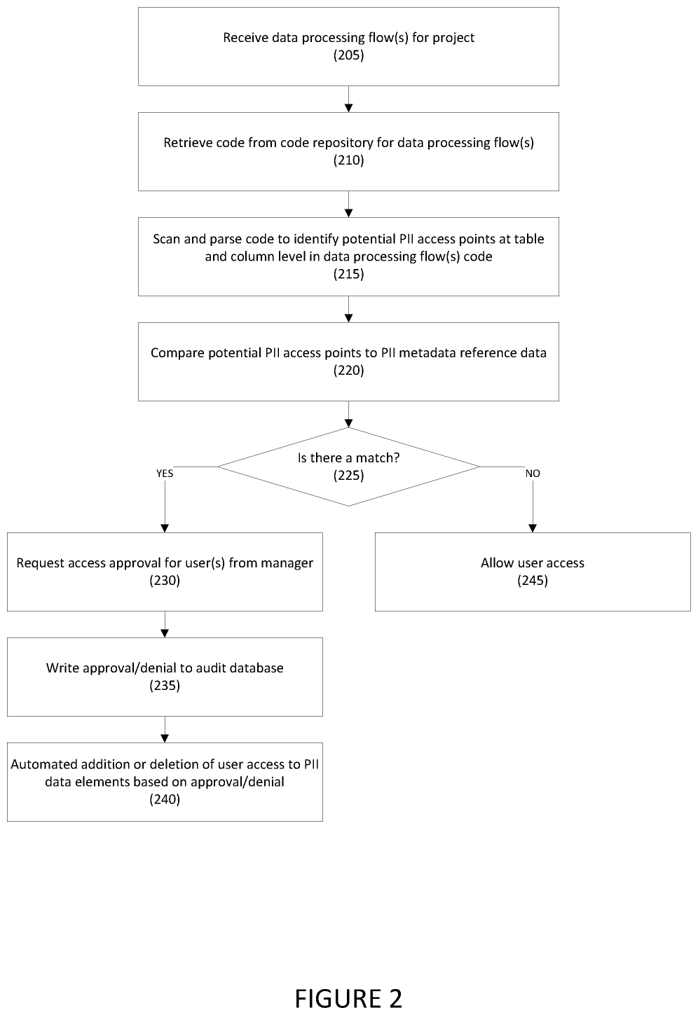

Referring to FIG. 2, a method for personally identifiable information metadata governance is disclosed according to one embodiment.

In step 205, a PII metadata identification program executed by an electronic device may receive a data processing flow. In one embodiment, the data processing flow may include applications, programs, etc.

In step 210, the PII metadata identification program may retrieve code for the data processing flow from a code repository. In one embodiment, the code may be received as part of a code deployment, in response to code being queued for execution, etc. For example, the code may be received as part of a continuous deployment pipeline.

In step 215, the PII metadata identification computer program may identify potential PII access points in the code. In one embodiment, metadata in the code may be scanned and parsed to identify the potential PII access points, such as SQL queries, at the table and column level.

In step 220, the PII metadata identification program may determine whether the potential PII access points match the PII metadata reference data in a PII reference data database. In one embodiment, the PII metadata reference data may identify storage locations for PII within an organization at the table and column label, as well as a PII classification for the data elements at the storage location. The potential PII access points from the code may be compared to the PII storage locations in the PII metadata reference data.

In step 225, if there is a match, indicating that there is a PII issue, in step 230, the PII metadata identification program may require management approval before one or more user may access the PII as part of the project. Thus, the PII metadata identification program may generate a message (e.g., email, SMS, push message, etc.) and send the message to the manager(s) of the user(s) that may execute the workflow code and access the PII.

In step 235, the manager's approval or denial may be written to an audit database.

In step 240, the user(s) may be granted access, or their access may be removed, based on the manager's approval. For example, the user may grant, deny, or remove access using a user interface. Based on the manager's action, the user's entitlements may be modified to add an entitlement to the PII.

In step 225, if there is not a match, indicating no PII issue, in step 245, the user(s) may be granted access.

Although multiple embodiments have been described, it should be recognized that these embodiments are not exclusive to each other, and that features from one embodiment may be used with others.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

The processing machine used to implement the invention may utilize a suitable operating system.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for personally identifiable information (PII) metadata governance, comprising:
receiving, by a PII metadata identification program executed by an electronic device, a data processing flow for a project;
retrieving, by the PII metadata identification program, code for the data processing flow from a code repository;
identifying, by the PII metadata identification program, potential PII access points in the code;
determining, by the PII metadata identification program, that the potential PII access points match PII access points in a PII reference data database;
confirming, by the PII metadata identification program, that an individual assigned to the project is entitled access the PII data; and
granting, by the PII metadata identification program, access to the PII data to the individual.

2. The method of claim 1, wherein the potential PII access points are identified at a table and column level.

3. The method of claim 1, wherein the PII reference data database comprises metadata for data elements in an organization.

4. The method of claim 3, wherein the data elements are classified based whether they include PII.

5. The method of claim 1, wherein the PII metadata identification program identifies potential PII access points in the code by scanning and parsing the code to identify the potential PII access points.

6. The method of claim 1, wherein the potential PII access points comprise SQL queries.

7. The method of claim 1, wherein the step of confirming, by the PII metadata identification program, that an individual assigned to the project is entitled access the PII data comprises:
requesting, by the PII metadata identification program, approval for the individual to access the PII; and
receiving, by the PII metadata identification program, approval for the individual to access the PII.

8. The method of claim 1, further comprising:
generating, by the PII metadata identification program, an audit log comprising individuals entitled to access the PII.

9. An electronic device, comprising:
a computer processor; and
a memory storing a PII metadata identification program;
wherein, when executed by the computer processor, the PII metadata identification program causes the computer processor to:
receive a data processing flow for a project;
retrieve code for the data processing flow from a code repository;
identify potential PII access points in the code;
determine that the potential PII access points match PII access points in a PII reference data database;
confirm that an individual assigned to the project is entitled access the PII data; and
grant access to the PII data to the individual.

10. The electronic device of claim 8, wherein the potential PII access points are identified at a table and column level.

11. The electronic device of claim 8, wherein the PII reference data database comprises metadata for data elements in an organization.

12. The electronic device of claim 11, wherein the data elements are classified based whether they include PII.

13. The electronic device of claim 8, wherein the PII metadata identification program identifies potential PII access points in the code by scanning and parsing the code to identify the potential PII access points.

14. The electronic device of claim 8, wherein the potential PII access points comprise SQL queries.

15. The electronic device of claim 8, wherein the PII metadata identification program confirms that an individual assigned to the project is entitled access the PII data by requesting approval for the individual to access the PII and receiving approval for the individual to access the PII.

16. The electronic device of claim 8, wherein the PII metadata identification program further causes the computer processor to generate an audit log comprising individuals entitled to access the PII.

17. A system, comprising:
a first electronic device comprising a first computer processor and executing a PII metadata identification program;
a second electronic device comprising a second computer processor and executing a data processing flow for a project;
a code repository comprising code for the data processing flow; and
a PII reference data database identifying PII access points, wherein the PII reference data database comprises metadata for data elements in an organization, wherein the data elements are classified based whether they include PII;
wherein the PII metadata identification program:
receives the data processing flow for the project from the second electronic device;
retrieves the code for the data processing flow from the code repository;
identifies potential PII access points in the code by scanning and parsing the code to identify the potential PII access points;
determines that the potential PII access points match the identified PII access points in the PII reference data database;
confirms that an individual assigned to the project is entitled access the PII data by requesting approval for the individual to access the PII;
and receiving approval for the individual to access the PII; and
grants access to the PII data to the individual.

18. The system of claim 17, wherein the potential PII access points are identified at a table and column level.

19. The system of claim 17, wherein the potential PII access points comprise SQL queries.

20. The system of claim 17, wherein the PII metadata identification program generates an audit log comprising individuals entitled to access the PII.
